(19) United States
(12) Patent Application Publication
(10) Pub. No.: US 2010/0119725 A1
(43) Pub. Date: May 13, 2010

(54) Method for Producing a Thin-Film Fuel Cell

(76) Inventor: Pascal Brault, Saint Denis En Val (FR)

Correspondence Address: FULBRIGHT & JAWORSKI, LLP, 666 FIFTH AVE, NEW YORK, NY, 10103-3198, US

(21) Appl. No.: 12/085,875

(22) PCT Filed: Nov. 28, 2006
(86) PCT No.: PCT/FR2006/051241

§ 371 Date: Jan. 9, 2009

(30) Foreign Application Priority Data
Nov. 30, 2005 (FR) 05 53669

(51) Int. Cl. H01M 8/10; H01M 4/88

(52) U.S. Cl. 427/450

(57) ABSTRACT

The invention relates to a method for producing a thin-film fuel cell. The inventive method comprises plasma spraying a first porous carbon electrode on a gas-diffusing substrate in a vacuum chamber, wherein the first porous carbon electrode comprises a catalyst used to accelerate at least one chemical reaction that takes place in the fuel cell; depositing ion-conducting material on the first porous carbon electrode to provide a membrane having a thickness of less than 20 micrometers; and plasma spraying a second porous carbon electrode on the membrane in the vacuum chamber, wherein the second electrode comprises a catalyst.

### RELATED APPLICATIONS

This application is a §371 application from PCT/FR2006/051241 filed Nov. 28, 2006 which claims priority from FR 05 53669 filed Nov. 30, 2005, each of which is herein incorporated by reference in its entirety.

The present invention concerns a method for producing a fuel cell made of thin layers.

### BACKGROUND OF THE INVENTION

Fuel cells are used in many applications, and are particularly considered to be a possible alternative to the use of fossil fuels. In essence, these cells make it possible to directly convert a chemical energy source, for example hydrogen or ethanol, into electrical energy.

A fuel cell made of thin layers is composed of an ion-conducting membrane (or electrolyte), onto which an anode and a cathode are deposited on opposite sides.

The operating principle of such a cell is as follows: fuel is injected at the level of the cell's anode. This anode will then be the site of a chemical reaction that creates positive ions, particularly protons, and electrons. The protons are transferred through the membrane to the cathode. The electrodes are transferred through a circuit, their movement thus creating electrical energy. In addition, an oxidant that will react with the protons is injected into the cathode.

The electrodes of fuel cells are generally composed of carbon that has been catalyzed, for example with platinum.

The most common technique for producing a catalyzed electrode consists of using a carbon ink or cloth, which is deposited on a substrate and then covered with a catalyst ink, for example a platinum ink.

It is possible to successively deposit several layers of carbon and catalyst, in order to obtain a more homogenous electrode.

The drawback of these techniques is that the layers are relatively thick, since the known ink deposition techniques do not make it possible to create layers that are less than about ten micrometers thick.

Generally, a fuel cell is produced in several separate stages since first, the electrodes are created, and subsequently, they are assembled to an available membrane, for example a Nafion membrane. These separate stages increase a fuel cell's production time, since each of the different stages requires various operations, and also its cost.

Furthermore, Nafion membranes have the disadvantage of being relatively thick, since they have a thickness of more than 20 micrometers, and moreover the fuel cells created from them cannot operate at temperatures higher than 90° C., particularly due to the low density of the membranes. In essence, in a low-density membrane, the water is not sufficiently confined and evaporates quickly due to the temperature. And of course, water is an element that is indispensable to the operation of a fuel cell.

Moreover, Nafion membranes cannot be used at high temperatures due to the instability of this material above 90° C.

### OBJECTS AND SUMMARY OF THE INVENTION

The object of the invention is to eliminate at least one of the drawbacks mentioned above, particularly by offering a production process such that the cell can be produced entirely in one piece of equipment, or in two similar pieces of equipment that are connected.

More precisely, the invention concerns a method for producing a fuel cell made of thin layers. This method comprises the following steps:
a first porous carbon electrode is deposited, by plasma spraying in a vacuum chamber, on a gas-diffusing substrate, this electrode also comprising a catalyst, the catalyst being used to accelerate at least one of the chemical reactions taking place in the fuel cell,
a membrane made of ion-conducting material is deposited on this first electrode, this membrane preferably having a thickness of less than 20 micrometers, and
a second porous carbon electrode is deposited on the membrane by plasma spraying in a vacuum chamber, this second electrode also comprising a catalyst.

Utilizing plasma spraying in a vacuum chamber to deposit the carbon electrodes makes it possible to perfectly control the amount of carbon that is deposited, and thus to deposit wafer-thin layers.

Besides, to carry out this plasma spraying, it is possible to choose a deposition temperature that does not exceed the stability temperature of the membrane, i.e. 150° C. at the most.

Besides, the spraying is such that, diming deposition, the membrane is not altered, and does not lose its properties of protonic conduction.

Depending on the type of cell produced, various types of materials can be used; for example, the membrane can be composed of a proton-conducting material.

Preferably, the plasma used is a low-pressure Argon plasma, the pressure varying between 1 and 500 milli Torr (mT), excited by radio frequency, for example at a frequency equal to 13.56 Megahertz (MHz) and generated by an inductive plasma generator.

Plasma spraying makes it possible to produce thin layers, wherein the catalyst is diffused in a carbon layer whose thickness can be greater than 1 micrometer.

Likewise, in order for the membrane to have a thickness of less than 20 micrometers, it is deposited, in one embodiment, using a method known as PECVD (Plasma Enhanced Chemical Vapor Deposition).

The principle of plasma enhanced chemical vapor deposition is as follows:
the surface onto which the deposition is to be performed, i.e. onto which the first electrode is to be deposited, is heated,
using a low-frequency excitation, a plasma is created from gasses known as precursor gasses, which will react in the gaseous phase and on the surface to create the deposition.

In another embodiment, the membrane deposit is made by plasma spraying in a vacuum chamber.

In one embodiment, the membrane comprises a carbon network material with sulfonic end groups, and possibly fluorine. For this reason, the precursor gasses used for the chemical deposition are, for example, a carbon precursor gas such as styrene or 1-3 butadiene, and a sulfonic precursor gas such as triflic acid.

A membrane of this type has the advantage of being relatively dense, and thus of allowing the fuel cell to operate at temperatures of up to 150° C., without there being any damage to the membrane.

Moreover, the method of production via PECVD makes it possible to produce a membrane having a large number of sulfonic groups. This makes it possible to facilitate the transfer of protons from one electrode to another, since during their passage through the membrane, the protons are transmitted by passing from one sulfonic group to another.

Furthermore, membranes of carbon network material with sulfonic end groups and fluorine offer lower methanol permeability than conventional membranes, thus making it possible to reduce the methanol “crossover” phenomenon, i.e. the passage of the methanol through the membrane to the cathode, resulting in an oxidation of the methanol. This makes it possible, in the case of methanol fuel cells, to obtain better efficiency.

In addition, the plasma spraying used, for example, for the deposition of the first and the second electrode makes it possible to produce carbon layers with different morphologies, i.e., layers in which the size and the shape of the carbon grains differ. For example, the carbon grains can be spherical or even “bean” shaped. Because of these different morphologies, it is possible to produce carbon layers that are more or less porous so that, in one embodiment, the porosity of the carbon deposited is between 20% and 50%.

The method defined above can be used to produce electrodes for any type of fuel cell, such as hydrogen fuel cells like the PEMFC (Proton Exchange Membrane Fuel Cell) or methanol fuel cells like the DMFC (Direct Methanol Fuel Cell). The various components, particularly the catalyst, can be quite diverse. Thus, in one embodiment, the sprayed catalyst belongs to the group that includes:

platinum

platinum alloys such as platinum ruthenium, platinum molybdenum, and platinum tin

non-platinum metals such as iron, nickel and cobalt, and

any alloy of these metals.

Among the most commonly used alloys are the platinum ruthenium alloy, or even the platinum ruthenium molybdenum alloy.

The method as defined above makes it possible to produce a fuel cell in any order desired, since the first step for depositing an electrode is just as easily adapted to the deposition of an anode as a cathode.

Thus, in one embodiment, the first electrode deposited constitutes the anode of the fuel cell, and in another embodiment, the first electrode deposited constitutes the cathode.

This method of production also has the advantage of making it possible to produce an entire fuel cell with a single piece of equipment or two similar pieces of equipment, which may be connected. Thus, in one embodiment, the three steps of deposition, namely the deposition of the two electrodes and the deposition of the membrane are performed in a single vacuum chamber. This configuration has many advantages since it makes it possible to produce fuel cells with a production time and a cost that are relatively low.

However, in the case where the electrodes are deposited by plasma spraying and the membrane is deposited by plasma enhanced chemical vapor deposition, it may sometimes be necessary to take certain precautions in order not to degrade the quality of the fuel cells produced.

Thus, in one embodiment, it is useful, during the membrane deposition phase, to place target masks over the carbon and catalyst targets, so that they are not covered with the material constituting the membrane.

Likewise, it is useful, between two deposition phases, to completely empty the vacuum chamber so that there is no mixing of the various gasses used for the depositions.

One solution for avoiding these problems of interference between the various materials consists, in one embodiment, of performing the steps for depositing the electrodes in a first vacuum chamber, and the step for depositing the membrane in a second vacuum chamber that is connected to the first one by a vacuum airlock.

In this case, the gas-diffusing substrate serving as the substrate for the cell is preferably disposed on a movable substrate holder, making it possible to move the cell from one chamber to the other during production.

We observed that, during the operation of a fuel cell, the quantity of catalyst that is actually usable corresponds to a thickness of no More than a few micrometers. Moreover, this usable quantity of catalyst depends on the current density supplied by the cell.

It would therefore be advantageous, for both economic and environmental reasons, to be able to adapt the quantity of catalyst to the operating mode of the cell, in order to deposit only the quantity necessary.

For this reason, in one embodiment, the step of depositing the first and/or second porous carbon electrode comprises the steps of alternately and/or simultaneously depositing porous carbon and a catalyst onto the substrate, the thickness of each layer of porous carbon being chosen so that the catalyst deposited on this carbon layer is diffused practically throughout this layer, thus creating a layer of catalyzed carbon, the total thickness of catalyzed carbon in the electrode being less than 2 micrometers, and preferably equal to no more than 1 micrometer.

Being able to deposit the porous carbon and the catalyst in an alternative and/or simultaneous way makes it possible to obtain a carbon layer which is catalyzed either homogeneously in the thickness of the layer, or according to a predetermined concentration gradient. Thus, in a process according to the invention, it is made possible to deposit, in one step, simultaneously some carbon and some catalyst, and to deposit, in previous or later steps, only one or the other component, namely the catalyst or the carbon.

In some embodiments, the process may be such that there is none step of simultaneous deposit.

The carbon layers are composed of a non-compact stack of carbon balls, connected to one another so as to allow the free circulation of the electrons.

Thus, as explained above, in a fuel cell, the chemical reaction that takes place in the anode is a reaction that creates ions. In order for the cell to operate properly, these ions must be transmitted to the anode, which generally occurs via the membrane (electrolyte), which is made of an ion-conducting material.

If the active catalytic phase of the anode is of substantial thickness, certain ions are created at a distance from the membrane such that they cannot be properly transmitted, since the carbon and the catalyst are not ion-conducting materials.

Likewise, in the case where the fuel cell produced is such that the chemical reaction in the cathode creates negative ions, if the active catalytic phase of the cathode is too thick, some of these ions cannot be properly transmitted through the membrane.

It is therefore advantageous that, in one embodiment, the step of depositing the first and/or second carbon electrode also includes the step of depositing, after at least one deposition of catalyst, an ion conductor such as “Nafion.” Thus, the ions created in the electrode, far from the membrane, will be transferred via this deposited ion conductor.

In order to best control the quantities deposited, in one embodiment, the ion conductor is deposited by plasma spraying. This spraying is preferably performed in the same vacuum chamber as the spraying of the carbon and the catalyst.

As explained above, in a fuel cell, the active quantity of catalyst varies as a function of the current density delivered, and hence also as a function of the operating power of the cell. This variation is particularly due to the competition between the phenomena of reactant supply and an electrode's ionic resistance. Depending on the desired operating mode, it is advantageous to have greater or lesser quantities of catalyst based on the distance from the membrane.

To account for these variations, in one embodiment, the ratio between the number of atoms of catalyst and the number of atoms of carbon present in the successive layers of catalyzed carbon varies according to a given profile.

It is possible, for example, to define a profile that corresponds to the production of a fuel cell that delivers a relatively high current, for example a current higher than 800 mW/cm², i.e., a cell operating at high power, high power being considered to begin at 500 mW/cm².

In this case, in order to create a high current density, it is necessary to supply the electrode with a large quantity of fuel. In order for this high flow of fuel to be able to react properly, it is necessary to have a large quantity of catalyst near the membrane.

For this reason, in one embodiment, in order to produce a fuel cell whose operating power is higher than a given value, for example 500 mW/cm², the quantity of catalyst deposited on the carbon layer nearest the membrane of the fuel cell is such that the ratio between the number of atoms of catalyst and the number of atoms of carbon present in the layer of catalyzed carbon thus created is greater than 20%, in a thickness of less than 100 nm, which results in a total quantity of platinum that is less than or equal to 0.1 mg/cm².

Likewise, it is possible to define a profile for fuel cells operating a low power, i.e. at a power of less than 500 mW/cm². Since this cell is designed to deliver a relatively low current, it is not necessary to have a large quantity of catalyst near the membrane. In this case, the primary objective is to reduce the quantity of catalyst used in the electrode assembly as much as possible, in order to reduce costs.

For this reason, in one embodiment, in order to produce a fuel cell whose operating power is lower than a given value, for example 500 mW/cm², the quantity of catalyst deposited on the carbon layer nearest the membrane of the fuel cell is such that the ratio between the number of atoms of catalyst and the number of atoms of carbon present in the catalyzed carbon layer thus created is less than 20%.

In another embodiment, in order to obtain a fuel cell whose power is lower than a given value, for example 500 mW/cm², the quantities of catalyst deposited are such that the ratio of the number of atoms of catalyst to the number of atoms of carbon present in the catalyzed carbon layer nearest the membrane of the fuel cell is more than 10 times greater than the ratio of the number of atoms of catalyst to the number of atoms of carbon present in the catalyzed carbon layer furthest from this membrane.

In another embodiment, the method is such that the porous carbon layers deposited all have the same thickness.

### BRIEF DESCRIPTION OF THE DRAWINGS

The invention also concerns a fuel cell made of thin layers produced according to the production method defined above.

Other characteristics and advantages of the invention will emerge from the nonlimiting description of some of its embodiments, this description being provided in connection with the figures, in which:

FIG. 1 presents two vacuum chambers that make it possible to produce a fuel cell using a method according to the invention,

FIG. 2 illustrates the principle of the plasma spraying used in a method according to the invention,

FIG. 3 shows the structure of a carbon layer onto which a catalyst and an ion conductor have been sprayed,

FIGS. 4a and 4b represent two profiles for the distribution of a catalyst in an electrode for fuel cells operating at high and low power, respectively, and

FIG. 5 is a timing diagram that shows the alternating sprayings of carbon and platinum in a method according to the invention.

### DESCRIPTION OF THE EMBODIMENTS

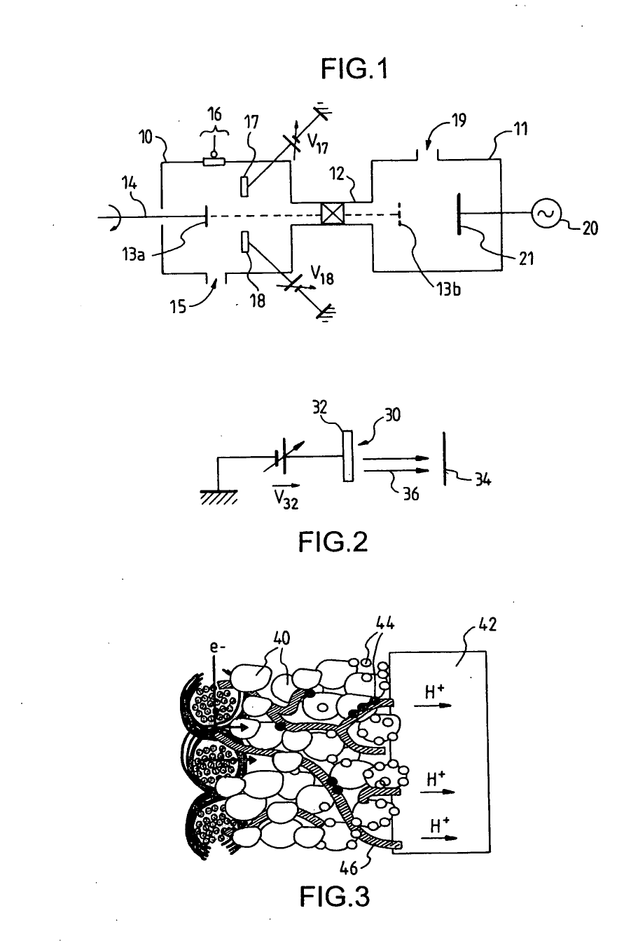

FIG. 1 presents a cross-sectional view of two vacuum chambers 10 and 11, connected by an airlock 12, which is also under vacuum. These two chambers make it possible to deposit the various elements of a fuel cell onto a gas-diffusing substrate. The substrate is installed on a substrate holder 14 that makes it possible to rotate this substrate around the normal to its main surface, so as to deposit the various substances uniformly. The substrate holder is also moveable, so that the substrate can be moved from a position 13a to a position 13b in order to allow the various production steps to be performed.

Inside the chamber 10 are three targets—only two of which are represented in FIGS. 1 (17 and 18)—which are targets of porous carbon, a catalyst such as platinum, and an ion conductor such as Nafion, respectively. These targets are respectively polarized with variable voltages V17 and V18.

In one example, different from the one represented in this figure, a first target is positioned facing the substrate, and the other two are positioned on either side of this first target, so that the normals to their main surfaces each form an angle of less than 45° with the normal to the substrate.

In a first step, which consists of depositing a first electrode onto the gas-diffusing substrate, the substrate is in position 13a, and the carbon, the platinum and the Nafion are successively sprayed using a low-pressure plasma spray in which Argon ions 15 are excited by a radio frequency antenna 16.

The principle of this type of spraying is illustrated in FIG. 2. Argon ions 30, emitted by an argon plasma, are sent to a target 32 of material to be sprayed on a substrate 34. The plasma state is produced by a high-power electrical discharge through the argon gas. The target is polarized with a variable voltage V32. As a result of the impact of these ions 30 on the target, the atoms of the target are released through a series of collisions. These atoms are then projected (36) onto the substrate 34.

Inside the chamber 10, the argon ions 15 are continuously bombarded onto the three targets. The three targets are then successively fed so as to deposit on the substrate a layer of porous carbon, then the catalyst, and finally the ion conductor. These three successive sprayings make it possible to form on the substrate a layer of catalyzed carbon that also contains atoms of an ion conductor.

A layer of this type is represented in FIG. 3. During the first spraying, porous carbon balls, generally with a diameter between 30 and 100 nm, are deposited on a substrate 42. During a second spraying, balls of platinum 44, generally with a diameter of less than 3 nm, are diffused into the layer of carbon and are thereby distributed among the carbon balls 40 deposited previously. To complete the process, during a third spraying, an ion conductor (46) such as Nafion is sprayed onto the catalyzed carbon layer.

The operation consisting of these three sprayings is then repeated several times, in order to form an electrode having the desired thickness.

The thickness of each porous carbon layer is chosen so as to allow the catalyst deposited subsequently to be diffused practically throughout the thickness of this carbon layer. The thickness of each carbon layer is preferably substantially less than 1 micrometer.

To facilitate the production process, the various carbon layers preferably have the same thickness. It is possible, however, to produce carbon layers of different thicknesses.

The polarization voltages V17 and V18 (FIG. 1) being variable, it is possible to control the number of atoms projected in each spraying. This makes it possible to form electrodes having profiles for the distribution of catalyst through the thickness that are adapted to the desired use of the fuel cell.

If it is also necessary to deposit an ion conductor, for the reasons mentioned above, this conductor must be distributed in the same way as the catalyst in order to ensure the transmission of the protons through the membrane.

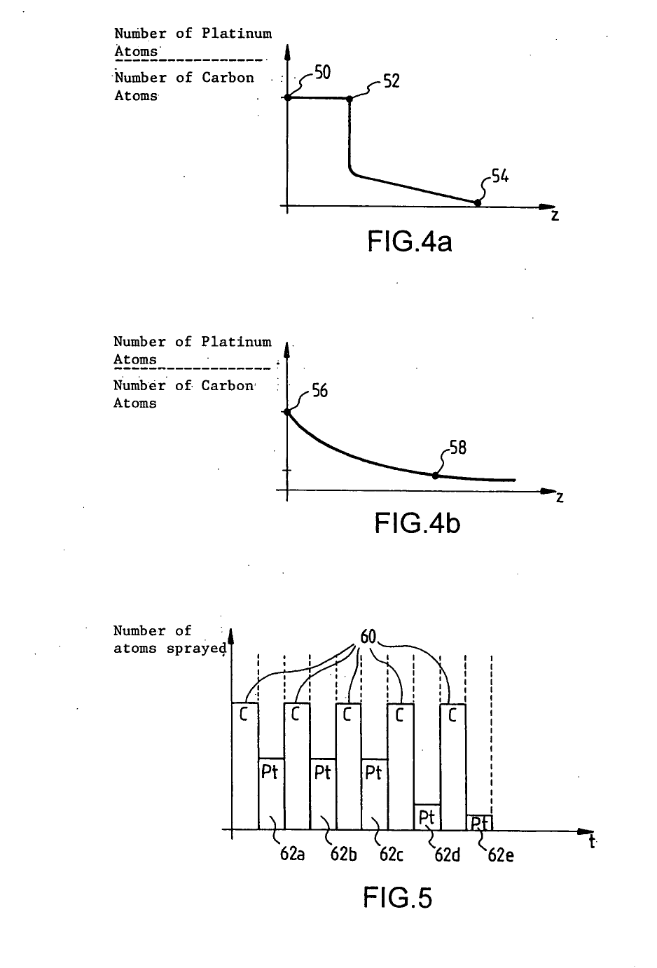

Two examples of these profiles are illustrated in FIGS. 4a and 4b. In these two curves, the axis of the abscissas represents the thickness of the electrode, the abscissa 0 corresponding to the point nearest the membrane, and the axis of the ordinates represents the ratio between the number of platinum atoms and the number of carbon atoms present in the electrode.

FIG. 4a presents an electrode profile that is particularly adapted to high power operation, i.e. for powers higher than 500 mW/cm².

At the point 50, the ratio between the number of platinum atoms and the number of carbon atoms is 50%, and the quantity of platinum is 10 grams per cubic centimeter. This quantity remains constant in a thickness of around 0.33 micrometer, until it reaches the cutoff point 52. From that point on, the quantity of platinum decreases quite rapidly, reaching a value of nearly zero for an electrode thickness equal to 1 micrometer (54).

FIG. 4b presents an electrode profile that is particularly adapted to low power operation, i.e. for powers lower than 500 mW/cm².

At the point 56, the ratio between the number of platinum atoms and the number of carbon atoms is 20%, and the quantity of platinum is 6 grams per cubic centimeter. This quantity diminishes progressively until it reaches (58) a value of 0.6 gram per cubic centimeter, for a thickness of less than 1 micrometer, then remains constant up to a maximum thickness of 2 micrometers.

One way to obtain these profiles is to spray the same quantity of carbon in each spraying, and to vary the quantity of platinum sprayed. This type of sequencing is illustrated by the timing diagram in FIG. 5.

In this timing diagram, the axis of the abscissas represents time, and the axis of the ordinates represents the number of atoms sprayed.

We see in this timing diagram that the number of atoms of porous carbon sprayed is the same each time (60).

On the other hand, the number of platinum atoms varies. In this example, during the first three passes 62a, 62b and 62c, the number of platinum atoms sprayed is equal for each pass. However, this number decreases sharply during passes 62d and 62e. This timing diagram shows only the initial sprayings of the deposition. After that, for example, the carbon sprayings remain the same, and the platinum sprayings continue to decrease.

The total number of passes is generally between 2 and 20, and the time required to deposit the electrode is less than 10 minutes. In one example, all of the passes have the same duration, equal to 30 seconds, and there are 10 carbon deposition phases and 10 catalyst deposition phases.

An electrode deposited in accordance with a timing diagram of this type has a profile similar to the one in FIG. 4a. In essence, the first three sprayings of platinum (62a through 62c) correspond to the portion of the profile located between the points 50 and 52 (FIG. 4a), while the sprayings 62d and so on correspond to the portion located between the points 52 and 54 (FIG. 4a).

In a variant, one (or more) spraying(s) of platinum can be followed by a spraying of ion conductor.

In order to perform electrode depositions based on a chosen timing diagram, it is possible, for example, to use a computer that contains the file in memory and is used to control the variable voltages V17 and V18 so as to obtain the desired profile.

After the deposition of the first electrode, the airlock 12 is opened so as to allow the substrate holding this first electrode to moved to the position 13b.

The chamber 11 is then the site of the deposition of a membrane via plasma enhanced chemical vapor deposition.

In the example illustrated in this FIG. 1, the intent is to deposit a membrane comprising a fluorinated carbon network and sulfonic end groups. To do this, precursor gasses (19) are introduced into the chamber: styrene, which is a carbon precursor gas, and triflic acid, which contains the sulfonic precursor and a fluorinated group. These gasses are then excited by means of a source 21 fed by a low-frequency generator 20 until they are in a plasma phase. In this phase, the precursor gasses react inside the volume of gas to form the final precursors, which are adsorbed on the surface and react with one another to form the membrane.

After this step of depositing the membrane, the substrate, which now carries a first electrode and the membrane, is moved back to its first position 13a.

The next step consists of depositing the second electrode, using a method of the same type as that used for the deposition of the first electrode.

Depending on the type of cell to be produced, the two electrodes could be completely different from one another, or even symmetrical relative to the membrane.

In the case where two symmetrical electrodes are to be deposited, the timing diagram for the deposition of the second electrode corresponds to the timing diagram for the deposition of the first one, in which the successive depositions of catalyst are performed in the reverse order, from a chronological point of view.

1-18. (canceled)

19. A method for producing a fuel cell made of thin layers, comprising the steps of:
plasma spraying a first porous carbon electrode on a gas-diffusing substrate in a vacuum chamber, wherein said first porous carbon electrode comprises a catalyst used to accelerate at least one chemical reaction that takes place in said fuel cell;
depositing ion-conducting material on said first porous carbon electrode to provide a membrane having a thickness of less than 20 micrometers; and
plasma spraying a second porous carbon electrode on said membrane in said vacuum chamber, wherein said second electrode comprises a catalyst.

20. The method of claim 19, wherein the step of depositing uses a plasma enhanced chemical vapor deposition.

21. The method of claim 19, wherein the step of depositing further comprises depositing a carbon network with sulfonic end groups or fluorine.

22. The method of claim 19, wherein at least one of the steps of plasma spraying deposits carbon electrode of a porosity between 20% and 50%.

23. The method of claim 19, wherein at least one of the steps of plasma spraying deposits said catalyst selected from a group consisting of: platinum; platinum alloys, platinum ruthenium, platinum molybdeum, platinum tin, platinum metals, iron, nickel, cobalt and alloys thereof.

24. The method of claim 19, wherein the step of plasma spraying the first porous carbon electrode deposits said first porous carbon electrode constituting an anode of said fuel cell.

25. The method of claim 19, wherein the step of plasma spraying the first porous carbon electrode deposits said first porous carbon electrode constituting an cathode of said fuel cell.

26. The method of claim 19, wherein the steps of plasma spraying the first porous carbon electrode, depositing a membrane, and plasma spraying a second porous carbon electrode are all performed in a single vacuum chamber.

27. The method of claim 19, wherein the steps of plasma spraying the first and second porous carbon electrodes are performed in a first vacuum chamber and wherein the step of depositing said membrane is performed in a second vacuum chamber connected to said first vacuum chamber by a vacuum airlock.

28. The method of claim 19, wherein at least one of the steps of plasma spraying further comprises the steps of alternately or simultaneously depositing a layer of porous carbon and said catalyst onto said gas-diffusing substrate or said membrane and selecting a thickness of each layer of said porous carbon such that said catalyst deposited on said each layer of said porous carbon is diffused essentially throughout said each layer of said porous carbon, thereby providing a layer of catalyzed carbon less than 2 micrometer.

29. The method of claim 28, further comprising the step of depositing an ion conductor or “Nafion” after at least one deposition of said catalyst.

30. The method of claim 28, further comprising the step of plasma spraying an ion conductor or “Nafion” after at least one deposition of said catalyst.

31. The method of claim 28, wherein the step of alternately or simultaneously depositing further comprising the step of varying a ratio between a number of atoms of said catalyst and a number of carbon atoms present in said layer of catalyzed carbon according to a predetermined thickness profile of said first or second porous carbon electrode.

32. The method of claim 28, wherein the step of alternately or simultaneously depositing further comprises the step of depositing a quantity of said catalyst on a layer of said porous carbon nearest said membrane of said fuel cell such that a ratio between a number of atoms of said catalyst and a number of carbon atoms present in said layer of catalyzed carbon is less than 50% to produce said fuel cell that has an operating power higher than 500 mW/cm².

33. The method of claim 28, wherein the step of alternately or simultaneously depositing further comprises the step of depositing a quantity of said catalyst on a layer of said porous carbon nearest said membrane of said fuel cell such that a ratio between a number of atoms of said catalyst and a number of carbon atoms present in said layer of catalyzed carbon is less than 20% to produce said fuel cell that has an operating power lower than 500 mW/cm².

34. The method of claim 28, wherein the step of alternately or simultaneously depositing further comprises the step of depositing quantities of said catalyst such that said ratio of a number of atoms of said catalyst to a number of carbon atoms present in a catalyzed carbon layer nearest said membrane of said fuel cell is more than 10 times greater than the ratio of said number of atoms of said catalyst to said number of carbon atoms present in a catalyzed carbon layer furthest from said membrane to produce a fuel cell with a power lower than 500 mW/cm².

35. The method of claim 28, wherein the step of alternately or simultaneously depositing further comprises the step of depositing porous carbon such that said each layer of porous carbon has the same thickness.
